(19) United States
(12) Patent Application Publication
(10) Pub. No.: US 2017/0031207 A1
(43) Pub. Date: Feb. 2, 2017

(54) 3D PRINTING IMAGING SYSTEM, 3D PRINTING IMAGING METHOD AND 3D PRINTING DEVICE

(71) Applicant: BOE TECHNOLOGY GROUP CO., LTD., Beijing (CN)

(72) Inventor: Wenbo Li, Beijing (CN)

(73) Assignee: BOE TECHNOLOGY GROUP CO., LTD., Beijing (CN)

(21) Appl. No.: 15/034,704

(22) PCT Filed: Sep. 25, 2015
(86) PCT No.: PCT/CN2015/090711

§ 371 Date: May 5, 2016

(30) Foreign Application Priority Data
Apr. 21, 2015 (CN) 201510189421.8

(51) Int. Cl. G02F 1/1335; B29C 67/00; G02F 1/1343

(52) U.S. Cl. CPC G02F 1/133528; G02F 1/133512; G02F 1/13439; B29C 67/0085; G02F 2001/133302

(57) ABSTRACT

A three-dimension (3D) printing imaging system, including: a liquid crystal display device; the liquid crystal display device includes a plurality of pixel modules; each pixel module includes at least one sub-pixel; the at least one sub-pixel is integrally manufactured; and light passing through the at least one sub-pixel is of a same color. A 3D printing imaging method includes: displaying an image of a product through the liquid crystal display device, and performing 3D printing by taking the image displayed on the liquid crystal display device as a template. A 3D printing device includes the imaging system.

### TECHNICAL FIELD

Embodiments of the present disclosure relate to a (three-dimension) 3D printing imaging system, a 3D printing imaging method and a 3D printing device.

### BACKGROUND

3D printing is a new rapid molding and manufacturing technology, and is used to manufacture products on a multilayer superimposition growing principle, which can overcome the barrier for special structures that cannot be realized by a conventional machining method, and can achieve simplified production of any complex structural components.

### SUMMARY

Embodiments of the present disclosure relate to a (three-dimension) 3D printing imaging system, a 3D printing imaging method and a 3D printing device, for simplifying the structure of the system and imaging modes and reducing costs.

At least an embodiment of the present disclosure provides a three-dimension (3D) printing imaging system, comprising a liquid crystal display device, wherein, the liquid crystal display device includes a plurality of pixel modules; each of the plurality of pixel modules includes at least one sub-pixel; the at least one sub-pixel is integrally manufactured; and the at least one sub-pixel is configured for allowing light of a same color to pass therethrough.

In some examples, the light of the same color is of white light.

In some examples, three sub-pixels are all of the same kind.

In some examples, the imaging system further comprises: a transparent liquid storage tank, a lifting rod support plate capable of doing vertical motion, and a light-emitting component; the liquid storage tank, the liquid crystal display device and the light-emitting component are arranged in sequence from top to bottom; a liquid photopolymerizable material is held in the liquid storage tank; and the lifting rod support plate is arranged in the photopolymerizable material.

In some examples, the photopolymerizable material includes a photopolymerizable resin.

Another embodiment of the present disclosure provides a three-dimension (3D) printing imaging method, and the imaging method comprising: displaying an image of a product through the liquid crystal display device, and performing 3D printing by taking the image displayed on the liquid crystal display device as a template.

In some examples, the displaying an image of a product through the liquid crystal display device includes: converting a three-dimensional data model file of the product into a standard template library file; dividing the standard template library file into a plurality of slices with a preset thickness, and transmitting two-dimensional data of each slice to the liquid crystal display device; applying a maximum working voltage or a minimum working voltage to the liquid crystal display device to drive sub-pixel modules on the liquid crystal display device to be fully transparent or light-tight so that an image of the two-dimensional data of each slice is respectively displayed in white or black on the liquid crystal display device.

In some examples, the performing 3D printing by taking the image displayed on the liquid crystal display device as a template includes: projecting the image of the two-dimensional data of each slice displayed on the liquid crystal display device onto the photopolymerizable material in sequence through a light-emitting component, and exposing layer by layer to form cured layers; and lifting up the cured layer formed by exposure of each slice in sequence through a lifting rod support plate so that all the cured layers are superposed in sequence to form a whole product.

In some examples, the maximum working voltage is 5 V, and the minimum working voltage is 0 V.

Further another embodiment of the present disclosure provides a three-dimension (3D) printing device, comprising any of the above-described imaging systems.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 illustrates a structural schematic diagram of a liquid crystal display device of a 3D printing imaging system provided by an embodiment of the present disclosure;

FIG. 2 illustrates a structural schematic diagram of a 3D printing imaging system provided by another embodiment of the present disclosure;

FIG. 3 illustrates a structural schematic diagram of a liquid crystal display device of an imaging system of a 3D printing imaging device provided by another embodiment of the present disclosure;

FIG. 4 illustrates a structural schematic diagram of a pixel module provided by another embodiment of the present disclosure;

FIG. 5 illustrates a structural schematic diagram of a pixel module provided by another embodiment of the present disclosure;

FIG. 6 illustrates a flow diagram of a 3D printing imaging method provided by another embodiment of the present disclosure; and

FIG. 7 illustrates a flow diagram of a 3D printing imaging method provided by another embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

In a 3D printing device, generally imaging is performed by a projector, and the chip in the projector is a silicon wafer comprising thousands of tiny reflective mirrors, and herein each “mirror” represents a pixel; control plates on the surface of the chip swing back and forth to control images entering a lens, and the switches of the control plates are controlled according to the number of colors; a front part of the chip is provided with a multicolor color wheel; there is a certain distance between the color wheel and a bulb; during operation, each “pixel” on the chip can be in constant motion state, and meanwhile, illumination light transmits the color wheel and is projected onto the chip, so different gray scales can be generated at any moments, and finally, adjusted rays are projected onto a screen to generate images.

Moreover, the inventor discovers that a 3D printing device using the projector is relatively complicated in imaging structure and imaging mode, and is higher in cost.

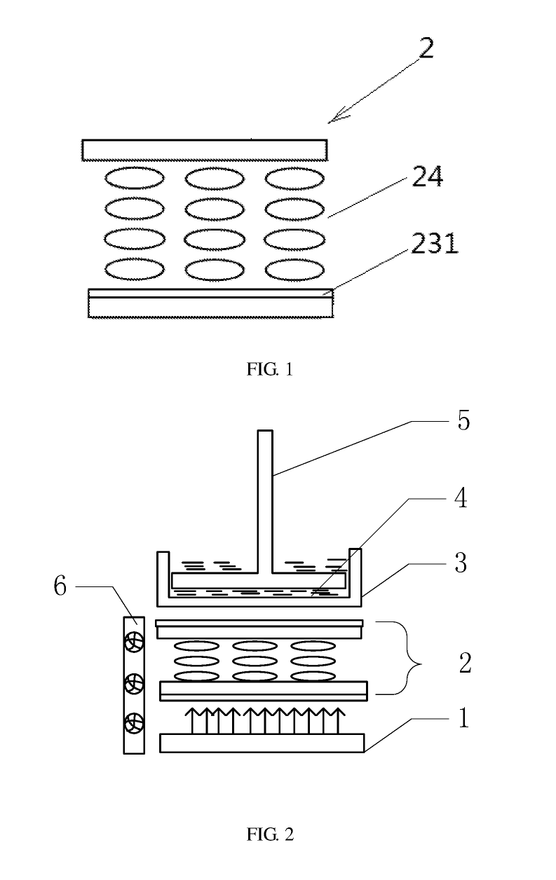

As illustrated in FIG. 1, at least one embodiment of the present disclosure provides a 3D printing imaging system; the imaging system includes a liquid crystal display device 2; the liquid crystal display device 2 includes a plurality of pixel modules; each of the plurality of pixel modules includes at least two sub-pixels 231; the at least two sub-pixels 231 are integrally manufactured; and light passing through the at least two sub-pixels 231 is of a same color.

For example, in one embodiment of the present disclosure, each pixel module can include a sub-pixel 231.

In the 3D printing imaging system, the 3D printing imaging method and the 3D printing device provided by the embodiments of the present disclosure, a three-dimensional data model file for a product is divided into a plurality of slices, then, the information of each slice is formed into a two-dimensional data image and the two-dimensional data image is transmitted to a computer, then, image processing is performed on the two-dimensional data images, and next, a maximum working voltage or a minimum working voltage is applied to the liquid crystal display device 2 to drive the sub-pixels 231 on the liquid crystal display device 2 to be fully transparent or fully light-tight (if a region displaying a product shape is white, then the sub-pixels are fully transparent; if a non-display region is black, then the sub-pixels are fully light-tight), so the liquid crystal display device 2 can display images with two colors of black and white, i.e., the images of the two-dimensional data of each slice. The region of the liquid crystal display device for displaying the black image is an ultraviolet shielding region, so a photopolymerizable material (such as photopolymerizable resin) is not exposed; while the region for displaying the white image is an ultraviolet transmitting region, so the photopolymerizable material (such as photopolymerizable resin) can be exposed by ultraviolet, and therefore a function of a light valve switch is realized, without multi-gray scale display.

In the 3D printing imaging system, the 3D printing imaging method and the 3D printing device provided by the embodiments of the present disclosure, as the liquid crystal display device 2 can display a black image and a white image, and red, green, and blue (R/G/B) color filters are not needed, the plurality of sub-pixels already become unnecessary. In the embodiments of the present disclosure, an integral sub-pixel 231 can be arranged at a position where three sub-pixels 231 would be arranged originally to replace these three sub-pixels, so that the imaging structure become simple, and the manufacturing cost is greatly reduced. Furthermore, for example, when a maximum voltage Lmax is applied to the liquid crystal display, the rays fully transmit through the sub-pixels; for example, when a minimum voltage Lmin (e.g., the minimum voltage is 0) is applied to the liquid crystal display, no rays transmit through the sub-pixels, and therefore, as long as the voltages over data lines 232 for driving liquid crystals 24 are set to two states: a maximum working voltage state and a minimum working voltage state, the sub-pixels 231 on the liquid crystal display device 2 can be driven to be fully transparent or light-tight.

In the 3D printing imaging system, the 3D printing imaging method and the 3D printing device provided by the embodiments of the present disclosure, the images of the two-dimensional data of all the slices are respectively displayed in white or black on the liquid crystal display device 2, and the displayed images of the two-dimensional data of all the slices are projected onto the photopolymerizable material for exposure and curing, and finally, the cured materials are superposed to form a whole required product.

Therefore, the imaging system is simple in structure and convenient in operation; the imaging method is simple and easy to realize and is lower in cost, so that the whole 3D printing device is simple in structure, convenient in operation and lower in cost.

For example, the light of the same color is white light. The three sub-pixels 231 have two states of fully transparent or fully light-tight; when the three sub-pixels are fully transparent, white light simultaneously transmits to display a white image, and a black image is displayed when the three sub-pixels become fully light-tight.

As illustrated in FIG. 2, another embodiment of the present disclosure provides a 3D printing imaging system; the imaging system comprises: a transparent liquid storage tank 3, a liquid crystal display device 2 and a light-emitting component 1, which are arranged in sequence from top to bottom. A liquid photopolymerizable material 4 is held in the liquid storage tank 3, and a lifting rod support plate 5 capable of doing vertical motion is arranged in the photopolymerizable material 4.

According to the 3D printing imaging system provided by the embodiment of the present disclosure, data of the product are respectively transmitted to the liquid crystal display device 2 to display various images respectively; moreover, the various images displayed on the liquid crystal display device 2 are respectively projected onto the photopolymerizable material 4 through the light-emitting component 1 for exposure and curing, and finally, the cured materials are superposed to form a whole required product.

For example, referring to FIG. 2, another embodiment of the present disclosure also provides a 3D printing imaging method, comprising: converting a three-dimensional CAD (computer-aided design) entity data model file or a surface data model file of the product into a standard template library STL file; dividing the STL file into a series of slices with a preset thickness by means of software, and then, forming the information of each slice into a two-dimensional data image and transmitting the two-dimensional data image to a computer; performing image processing on the two-dimensional data images with a computer so as to enable a region displaying the product shape to be white and a region not displaying the product shape to be black; transmitting the processed two-dimensional data images to a liquid crystal display device, thereby displaying the images with black and white colors, i.e., the images of two-dimensional data of all slices, on the liquid crystal display device 2; with a light-emitting component, directly projecting the image of each slice displayed on the liquid crystal display device 2 onto the photopolymerizable material 4 in the liquid storage tank 3 for exposure, and exposing and then curing the photopolymerizable material 4 to form a layer of solid structure; during exposure and curing or after exposure and curing, lifting the finished solid structure corresponding to each slice by a certain distance with the lifting rod support plate 5, and thereby performing superposition processing on all layers of manufactured solid structures in sequence until the whole product is finished.

In the 3D printing imaging method, in an implementation mode, the black image and the white image need to be displayed; the black image region is an ultraviolet shielding region, so the photopolymerizable material (such as photopolymerizable resin) is not exposed; while the white image region is an ultraviolet transmitting region, so the photopolymerizable material (such as photopolymerizable resin) can be exposed by the ultraviolet.

The imaging system provided by an embodiment of the present disclosure is simple in structure and convenient in operation, and has a simple drive mode; the imaging method is simple and easy to realize, and is lower in cost.

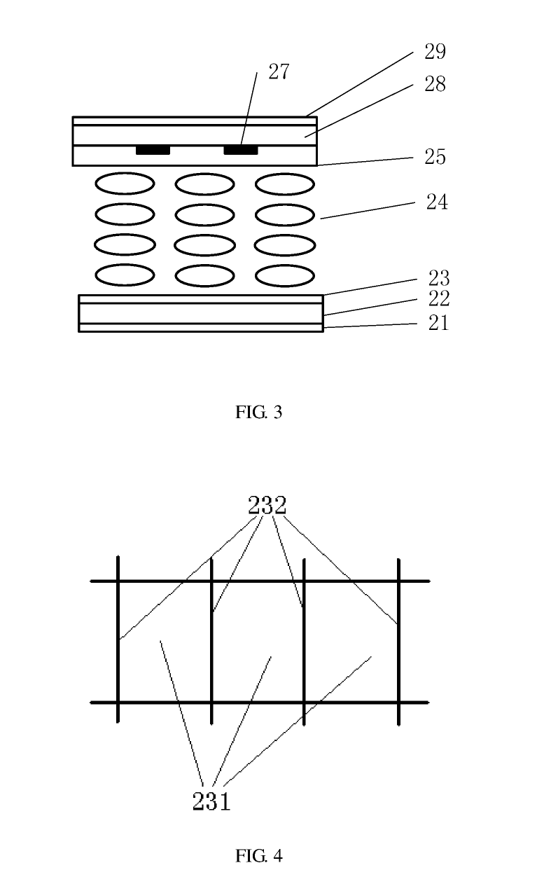

For example, in the imaging system provided by another embodiment of the present disclosure, as illustrated in FIG. 3, the liquid crystal display device 2 includes a first polarizing film 21, a first glass substrate 22, an array circuit 23, a liquid crystal 24, a common electrode 25, a second glass substrate 28 and a second polarizing film 29, which are arranged in sequence.

For example, a black matrix 27 can also be arranged in the common electrode 25 of the liquid crystal display device 2.

As illustrated in FIG. 3, the black matrix 27 is set to be corresponding to a region between the adjacent sub-pixels on the first glass substrate.

In the embodiment of the present disclosure, as the liquid crystal display device 2 can display black images and white images, the display device has no demands on color gamut, so the red, green, and blue (R/G/B) color filters of a multicolor pattern is not necessary to be formed (i.e., red, green, and blue (R/G/B) color filters between the common electrode 25 and the second glass substrate 28 of the liquid crystal display device 2 can be removed), and therefore, the structure of the liquid crystal display device 2 is simplified. Furthermore, as the red, green, and blue (R/G/B) color filters are removed, blocking to the light rays is reduced, and the transmittance of the light rays is greatly enhanced; as long as the light-emitting component 1 emits small amount of light, the exposure requirement can be met, so that the power consumption of the light-emitting component 1 can be obviously reduced. Moreover, the transmittance of the rays is enhanced so that the exposure time of the photopolymerizable material (such as photopolymerizable resin) is greatly shortened, thereby becoming more conducive to actual use.

The above-described change in structure brings about modification to the drive mode. As the operation of 3D printing actually involves performing mask projection exposure with the liquid crystal display device 2 as a light valve, as for all the pixel modules of the liquid crystal display device 2, two states, i.e., dark state and bright state, are needed (in the bright state, the region displaying the product shape in the liquid crystal display device is transparent and displays white; in the dark state, the region not displaying the product shape in the liquid crystal display device is light-tight and displays black), and therefore, the function of a light valve switch is realized without multi-gray scale display. For the bright state, the stronger the rays the better, in this manner, the more rays transmitting therethrough in the same period of time, the more conductive to exposure and curing of the photopolymerizable material 4, and therefore, the exposure time can be obviously shortened, and the production process efficiency is increased.

Furthermore, the data signal for driving the liquid crystal display device does not need to include a color gamut value but can include luminance values for representing the luminance of all the pixel modules of the display device, and moreover, the luminance is represented by only two numerical values, i.e., the maximum value Lmax when the light rays all transmit and the minimum value Lmin (e.g., the minimum is 0) when no light rays transmit at all; and therefore, the voltages over the data lines 232 for driving the liquid crystal 24 need to be set to two states: the maximum working voltage state and the minimum working voltage state, without a data signal for a median value, so that the amount of information of the data signals is greatly reduced. For example, if the maximum working voltage and the minimum working voltage are 5 V and 0 V respectively, the liquid crystal display device of the embodiment of the present disclosure can realize display only by means of one (1) bit of data information, while conventional liquid crystal display devices can realize display by means of eight (8) bit or 10 bit of data information.

Furthermore, the imaging system of the embodiment of the present disclosure is merely used for helping the two-dimensional data image of the product to be projected onto the photopolymerizable material 4 for exposure and curing, and is not mainly used for display by itself, so that adjustment is not needed, r visual correction cannot be needed, and the structure of the imaging system is simplified.

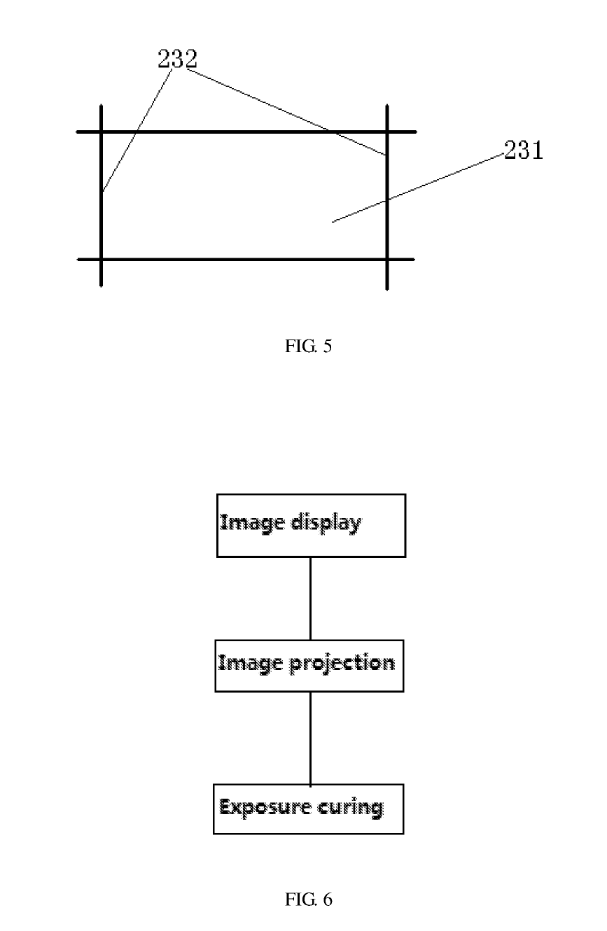

For example, as illustrated in FIG. 5, each pixel module of the array circuit 23 includes a single sub-pixel 231, i.e., the original three sub-pixels 231 are integrally manufactured.

For example, the sub-pixels 231 of each pixel module of the array circuit 23 are all identical sub-pixels 231.

In a conventional technology, as illustrated in FIG. 4, as a liquid crystal display device 2 needs to display color images, each pixel module on the liquid crystal display device 2 needs to be provided with three sub-pixels 231, i.e., three R/G/B sub-pixels 231, so as to realize different colors.

However, in the embodiment of the present disclosure, as illustrated in FIG. 5, as the liquid crystal display device 2 displays the black image and the white image, and the red, green, and blue (R/G/B) color filter is removed, the three sub-pixels 231 are already unnecessary, and the three sub-pixels 231 that would be arranged originally can be replaced with one sub-pixel 231 as a whole, and therefore the structure is simple, and the manufacturing cost is greatly reduced. Moreover, by comparing the pixel structure of the pixel module as illustrated in FIG. 5 with the pixel structure of the pixel module as illustrated in FIG. 4, two data lines 232 can be reduced for each pixel module, and therefore load for driving the pixel modules can be greatly reduced, and the power consumption is reduced. In addition, because the data lines 232 in the liquid crystal display device 2 are reduced, blocking to the rays is reduced, and the transmittance of the rays is promoted, which is more conductive to actual use.

The sub-pixels 231 of each pixel module are set to be the identical kind of sub-pixels 231, so that the liquid crystal display device can be conveniently produced in batches.

For example, as illustrated in FIG. 2, the photopolymerizable material 4 is photopolymerizable resin.

For example, as illustrated in FIG. 2, the imaging system may further comprise a cooling device 6, and the cooling device 6 is arranged nearby the light-emitting component 1.

For example, as illustrated in FIG. 2, the cooling device 6 is a fan.

The cooling device 6 can be flexibly adjusted in position so as to cool the imaging system of the embodiment of the present disclosure.

In the embodiment of the present disclosure, original R/G/B three-color signals can become unnecessary, so that data lines 232 are obviously reduced in number, corresponding circuit load and circuit power consumption are also obviously reduced, data signal circuit and other circuits can be greatly simplified in structure respectively, and the cost is greatly reduced.

Moreover, for original R/G/B signals that are possibly input, color conversion processing and luminance value extraction can be performed, and after data reprocessing, the processed signals are input into the liquid crystal display device 2. For example, the R/G/B signals are converted into YUV signals, where Y is a luminance signal, and U and V are both chroma signals; the luminance signal and the chroma signals are separated so as to facilitate image processing. Pixel relocation can be performed, data redistribution is performed on the liquid crystal display device 2, and original R/G/B data is synthesized into data only having luminance information. Then, the signals are transmitted into the liquid crystal display device 2 through T/con and are displayed.

As illustrated in FIG. 6, another embodiment of the present disclosure provides a 3D printing imaging method, comprising: displaying an image of a product through a liquid crystal display device 2, and performing 3D printing by taking the image displayed on the liquid crystal display 2 as a template.

According to the imaging method provided by an embodiment of the present disclosure, with the imaging system according to any one of the embodiments, data of the product is respectively transmitted to the liquid crystal display device 2, various images are respectively displayed, and the various images displayed on the liquid crystal display device 2 are respectively projected onto the photopolymerizable material 4 by means of the irradiation of the light-emitting component for exposure and curing; finally, the cured materials are superposed to form the whole required product, and therefore the imaging system of the embodiment of the present disclosure is simple in structure and convenient in operation; the imaging method is simple and easy to realize, and is lower in cost.

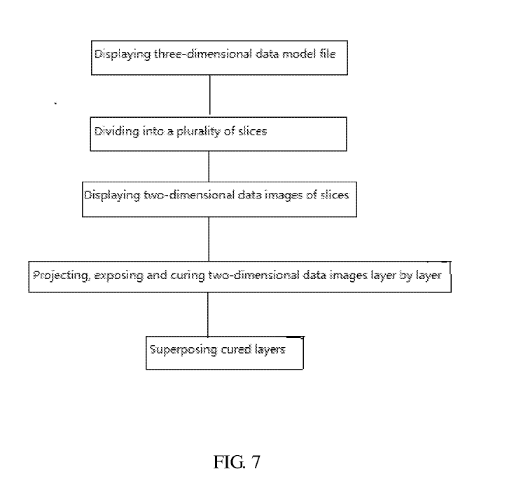

As illustrated in FIG. 7, the displaying the image of the product through the liquid crystal display device 2 includes: converting a three-dimensional data model file of a product into a standard template library STL file; dividing the STL file into a plurality of slices with a preset thickness, and transmitting the two-dimensional data of each slice to a liquid crystal display device 2; applying a maximum working voltage or a minimum working voltage to the liquid crystal display device 2 to drive sub-pixels 231 on the liquid crystal display device 2 to be fully transparent or light-tight so that image of the two-dimensional data of each slice is respectively displayed in white or black on the liquid crystal display device 2.

As illustrated in FIG. 7, in the embodiment of the present disclosure, the performing 3D printing by taking the image on the liquid crystal display device 2 as a template includes: projecting the images of the two-dimensional data of all the slices displayed on the liquid crystal display device 2 onto the photopolymerizable material in sequence by a light-emitting component, and exposing layer by layer to form cured layers; and lifting up the cured layers that have been formed by exposure of the corresponding slices by a lifting rod support plate 5 so that all the cured layers are superposed in sequence to form the whole product.

For example, the maximum working voltage is 5 V, and the minimum working voltage is 0 V.

For example, a 3D printing imaging method provided by an embodiment of the present disclosure includes steps of: converting a three-dimensional CAD (computer-aided design) entity data model file or a surface data model file for a product into a standard template library STL file; dividing the STL file into a series of slices with a preset thickness by means of software, and then, forming the information of each slice into a two-dimensional data image and transmitting the two-dimensional data image to a computer; performing image processing on the two-dimensional data images through a computer so as to enable a product shape region to be represented by white and a non-product shape region to be represented by black; transmitting the processed two-dimensional data images to a liquid crystal display device, thereby displaying the images with black and white colors, i.e., the images of two-dimensional data of all slices, on the liquid crystal display device 2; through a light-emitting component, directly projecting the image of each slice displayed on the liquid crystal display device 2 to the photopolymerizable material 4 in the liquid storage tank 3 for exposure, and exposing and then curing the photopolymerizable material 4 to form a layer of solid structure; during exposure and curing or after exposure and curing, lifting the finished solid structure corresponding to each slice by a certain distance with the lifting rod support plate 5, and thereby performing superposition processing on all layers of manufactured solid structures in sequence until the whole product is finally formed.

In the 3D printing imaging method, in an implementation mode, the black image and the white image are to be displayed; the black image region is an ultraviolet shielding region, so the photopolymerizable material (such as photopolymerizable resin) is not exposed; while the white image region is an ultraviolet transmitting region, so the photopolymerizable material (such as photopolymerizable resin) can be exposed by the ultraviolet.

The imaging system in the embodiment of the present disclosure is simple in structure and convenient in operation and has a simple drive mode; the imaging method is simple and easy to realize, and is lower in cost.

An embodiment of the present disclosure provides a 3D printing device, and the 3D printing device comprises the imaging system according to any one of the embodiments.

In the imaging system comprised by the 3D printing device provided by an embodiment of the present disclosure, by respectively transmitting data of a product to the liquid crystal display device 2, various images are respectively displayed, and the various images displayed on the liquid crystal display device 2 are respectively projected onto the photopolymerizable material 4 through the light-emitting component 1 for exposure and curing; finally, the cured materials are superposed to form a whole required product, and therefore the imaging system of the embodiment of the present disclosure is simple in structure and convenient in operation; the imaging method is simple and easy to realize, and is lower in cost, so that the whole 3D printing device is simple in structure, convenient in operation and lower in cost.

According to the 3D printing imaging system, the 3D printing imaging method and the 3D printing device provided by the embodiments of the present disclosure, by dividing the three-dimensional data file of the product into a plurality of slices and applying the maximum working voltage or the minimum working voltage to the liquid crystal display device, the sub-pixel modules on the liquid crystal display device are driven to be fully transparent or fully light-tight, so that the two-dimensional data image of each slice is respectively displayed in white or black on the liquid crystal display device, and the displayed two-dimensional data image of each slice is projected onto the photopolymerizable material for exposure and curing; finally, the cured materials are superposed to form the whole required product, and therefore the imaging system of the embodiments of the present disclosure is simple in structure and convenient in operation; the imaging method is simple and easy to realize, and is lower in cost, so that the 3D printing device is simple in structure, convenient in operation and lower in cost.

The above implementation modes are only intended to illustrate the exemplary embodiments of the present disclosure, rather than limiting the present disclosure, those ordinary skilled in the art can make various changes and modifications without departing from the spirit and scope of the present disclosure, all equivalent technical solutions are also within the scope of the present disclosure, and the patent protection scope of the present disclosure shall be defined by the claims.

The present application claims priority of Chinese Patent Application No. 201510189421.8 filed on Apr. 21, 2015, the present disclosure of which is incorporated herein by reference in its entirety as part of the present application.

1. A three-dimension (3D) printing imaging system, comprising a liquid crystal display device, wherein, the liquid crystal display device includes a plurality of pixel modules; each of the plurality of pixel modules includes at least one sub-pixel; the at least one sub-pixel is integrally manufactured; and the at least one sub-pixel is configured for allowing light of a same color to pass therethrough.

2. The imaging system according to claim 1, wherein the light of the same color is of white light.

3. The imaging system according to claim 2, further comprising: a transparent liquid storage tank, a lifting rod support plate capable of doing vertical motion, and a light-emitting component,
wherein the liquid storage tank, the liquid crystal display device and the light-emitting component are arranged in sequence from top to bottom; a liquid photopolymerizable material is held in the liquid storage tank; and the lifting rod support plate is arranged in the photopolymerizable material.

4. The imaging system according to claim 1, wherein the photopolymerizable material includes a photopolymerizable resin.

5. The imaging system according to claim 1, further comprising: a cooling device.

6. The imaging system according to claim 1, wherein the liquid crystal display device includes a first polarizing film, a first glass substrate, an array circuit, a liquid crystal, a common electrode, a second glass substrate and a second polarizing film, which are arranged in sequence.

7. The imaging system according to claim 6, wherein a black matrix is arranged in the common electrode.

8. A three-dimension (3D) printing imaging method, employing the 3D printing imaging system according to claim 1, the imaging method comprising:
displaying an image of a product through the liquid crystal display device, and performing 3D printing by taking the image displayed on the liquid crystal display device as a template.

9. The imaging method according to claim 8, wherein the displaying an image of a product through the liquid crystal display device includes:
converting a three-dimensional data model file of the product into a standard template library file;
dividing the standard template library file into a plurality of slices with a preset thickness, and transmitting two-dimensional data of each slice to the liquid crystal display device;
applying a maximum working voltage or a minimum working voltage to the liquid crystal display device to drive sub-pixel modules on the liquid crystal display device to be fully transparent or light-tight so that an image of the two-dimensional data of each slice is respectively displayed in white or black on the liquid crystal display device.

10. The imaging method according to claim 8, wherein the performing 3D printing by taking the image displayed on the liquid crystal display device as a template includes:
projecting the image of the two-dimensional data of each slice displayed on the liquid crystal display device onto the photopolymerizable material in sequence through a light-emitting component, and exposing layer by layer to form cured layers; and
lifting up the cured layer formed by exposure of each slice in sequence through a lifting rod support plate so that all the cured layers are superposed in sequence to form a whole product.

11. The imaging method according to claim 8, wherein the maximum working voltage is 5 V, and the minimum working voltage is 0 V.

12. A three-dimension (3D) printing device, comprising the imaging system according to claim 1.

13. The imaging system according to claim 2, wherein the photopolymerizable material includes a photopolymerizable resin.

14. The imaging system according to claim 2, further comprising: a cooling device.

15. The imaging system according to claim 2, wherein the liquid crystal display device includes a first polarizing film, a first glass substrate, an array circuit, a liquid crystal, a common electrode, a second glass substrate and a second polarizing film, which are arranged in sequence.

16. The imaging system according to claim 15, wherein a black matrix is arranged in the common electrode.

17. The imaging system according to claim 3, wherein the photopolymerizable material includes a photopolymerizable resin.

18. The imaging system according to claim 3, further comprising: a cooling device.

19. The imaging system according to claim 3, wherein the liquid crystal display device includes a first polarizing film, a first glass substrate, an array circuit, a liquid crystal, a common electrode, a second glass substrate and a second polarizing film, which are arranged in sequence.

20. The imaging method according to claim 9, wherein the performing 3D printing by taking the image displayed on the liquid crystal display device as a template includes:
projecting the image of the two-dimensional data of each slice displayed on the liquid crystal display device onto the photopolymerizable material in sequence through a light-emitting component, and exposing layer by layer to form cured layers; and
lifting up the cured layer formed by exposure of each slice in sequence through a lifting rod support plate so that all the cured layers are superposed in sequence to form a whole product.
